(19) United States
(12) Patent Application Publication
(10) Pub. No.: US 2002/0048542 A1
(43) Pub. Date: Apr. 25, 2002

(54) CATALYTIC TRAP AND METHODS OF MAKING AND USING THE SAME

(76) Inventors: MICHEL DEEBA, EAST BRUNSWICK, NJ (US); JOHN K. HOCHMUTH, BRIDGEWATER, NJ (US); SHAU-LIN F. CHEN, PISCATAWAY, NJ (US); ZHICHENG HU, EDISON, NJ (US); PATRICK L. BURK, FREEHOLD, NJ (US)

Correspondence Address: CHIEF PATENT COUNSEL, ENGELHARD CORPORATION, 101 WOOD AVENUE, P O BOX 770, ISELIN, NJ, 088300770

(21) Appl. No.: 09/323,658

(22) Filed: Jun. 1, 1999

Related U.S. Application Data
(60) Provisional application No. 60/127,489, filed on Apr. 2, 1999.

(51) Int. Cl. B01D 53/56; B01J 23/58

(52) U.S. Cl. 423/239.1; 502/328; 502/330

(57) ABSTRACT

A catalytic trap (10) for the treatment of exhaust generated by lean-burn or partial lean-burn engines is resistant to deactivation by high temperature, lean operating conditions aging. The catalytic trap (10 or 10′) comprises a carrier member (12 or 12/12′) on which is coated a catalytic trap material (20), optionally in discrete layers (20a, 20b) comprising a NOₓ sorbent and a refractory metal oxide support on which is dispersed a palladium catalytic component in an amount of at least 25 g/ft³ Pd up to about 300 g/ft³ Pd. A platinum and/or a rhodium catalytic component may also be present. The NOₓ sorbent may be one or more basic oxygenated compounds of an alkali metal and/or an alkaline earth metal, e.g., of cesium and/or barium. A method of making includes applying the NOₓ sorbent by a post-dipping technique. A method of use includes alternating lean and stoichiometric or rich periods of operation and optionally oxidizing hydrocarbons in the exhaust prior to contacting the exhaust with the catalytic trap (10).

### CROSS-REFERENCE TO RELATED APPLICATION

This application claims priority of provisional patent application Serial No. 60/127,489 of Michel Deeba et al entitled Catalytic Trap and Methods of Making and Using the Same, filed on Apr. 2, 1999.

### BACKGROUND OF THE INVENTION

1. Field of the Invention

The present invention relates to a catalytic trap for treating exhaust gas streams, especially those emanating from lean-bum engines, and to methods of making and using the same. More specifically, the present invention provides a catalytic trap which abates NOₓ in the exhaust streams being treated and exhibits enhanced durability after aging at high temperature and lean operation conditions.

2. Related Art

Emission of nitrogen oxides (“NOₓ”) from lean-burn engines must be reduced in order to meet emission regulation standards. Conventional three-way conversion (“TWC”) automotive catalysts are suitable for abating NOₓ, carbon monoxide (“CO”) and hydrocarbon (“HC”) pollutants in the exhaust of engines operated at or near stoichiometric air/fuel conditions. An air-to-fuel weight ratio of 14.65:1 is the stoichiometric ratio for a hydrocarbon fuel, such as gasoline, having an average formula CH_{1.88}. However, engines, especially gasoline-fueled engines to be used for passenger automobiles and the like, are being designed to operate under lean conditions as a fuel economy measure. Such future engines are referred to as “lean-burn engines”. That is, the ratio of air to fuel in the combustion mixtures supplied to such engines is maintained considerably above the stoichiometric ratio, e.g., at an air-to-fuel weight ratio of 18:1, so that the resulting exhaust gases are “lean”, i.e., the exhaust gases are relatively high in oxygen content.

Although lean-burn engines provide enhanced fuel economy, they have the disadvantage that conventional TWC catalysts are not effective for reducing NOₓ emissions from such engines because of excessive oxygen in the exhaust. The prior art discloses attempts to overcome this problem by operating lean-burn engines with brief periods of fuel-rich operation. (Engines which operate in this fashion are sometimes referred to as “partial lean-burn engines”.) It is known to treat the exhaust of such engines with a catalyst/NOₓ sorbent which stores NOₓ during periods of lean (oxygen-rich) operation, and releases the stored NOₓ during the rich (relatively fuel-rich) periods of operation. During periods of rich operation, the catalyst component of the catalyst/NOₓ sorbent promotes the reduction of NOₓ to nitrogen by reaction of NOₓ (including NOₓ released from the NOₓ sorbent) with HC, CO and/or hydrogen present in the exhaust.

The use of NOₓ storage (sorbent) components including alkaline earth metal oxides, such as oxides of Ca, Sr and Ba, alkali metal oxides such as oxides of K, Na, Li and Cs, and rare earth metal oxides such as oxides of Ce, La, Pr and Nd in combination with precious metal catalysts such as platinum dispersed on an alumina support, is known, as shown for example, at column 4, lines 19-25, of U.S. Pat. No. 5,473,887 of S. Takeshima et al, issued on Dec. 12, 1995. At column 4, lines 53-57, an exemplary composition is described as containing barium (an alkaline earth metal) and a platinum catalyst.

The publication Environmental Catalysts For A Better World And Life, Proceedings of the 1^{st} World Congress at Pisa, Italy, May 1-5, 1995, published by the Societa Chimica Italiana of Rome, Italy has, at pages 45-48 of the publication, an article entitled “The New Concept 3-Way Catalyst For Automotive Lean-Burn Engine Storage and Reduction Catalyst”, by Takahashi et al (below referred to as “the Takahashi et al paper”). This article discloses the preparation of catalysts of the type described in the above-mentioned Takeshima et al U.S. Pat. No. 5,473,887 by impregnating precious metals, mainly platinum, and various alkaline and alkaline earth metal oxides, mainly barium oxide, and rare earth oxides on refractory metal oxide supports, mainly alumina, and using these catalysts for NOₓ purification of actual and simulated exhaust gases alternately under oxidizing (lean) and reducing (rich or stoichiometric) conditions. The conclusion is drawn in the last sentence on page 46, that NOₓ was stored in the catalyst under oxidizing conditions and that the stored NOₓ was then reduced to nitrogen under stoichiometric and reducing conditions.

SAE Paper 950809 published by the Society of Automotive Engineers, Inc., Warrendale, Pa., and entitled Development of New Concept Three-Way Catalyst for Automotive Lean-Burn Engines, by Naoto Miyoshi et al, was delivered at the International Congress and Exposition, Detroit, Mich., Feb. 27-Mar. 2, 1995. This paper, which has authors in common with the above-mentioned Takahashi et al paper, contains a disclosure which is substantially the same as, but is more detailed than, that of the Takahashi et al paper.

U.S. Pat. No. 5,451,558, “Process For the Reaction and Absorption of Gaseous Air Pollutants, Apparatus Therefor and Method of Making the Same”, issued on Sep. 19, 1995 to L. Campbell et al, discloses a catalytic material for the reduction of NOₓ in combustion exhaust, e.g., from a gas turbine in a power generating stack. The material comprises an oxidation species and an adsorbent species. The oxidation species may comprise various metals including platinum group metals such as platinum, palladium or rhodium (see column 3, line 67, through column 4, line 3). The adsorbent species may comprise an alkali or alkaline earth metal carbonate, bicarbonate or hydroxide, and carbonates, especially sodium carbonate , potassium carbonate or calcium carbonate, are preferred. (See column 4, lines 24-31.) The catalytic material is applied by coating the carrier with, e.g., platinum-coated alumina and then wetting the alumina with an alkali or alkaline earth metal carbonate solution, and then drying the wetted alumina (see column 5, line 9, through column 6, line 12). The use of a metal monolith support for the material is suggested at column 5, lines 48-58.

U.S. Pat. No. 5,202,300, “Catalyst For Purification of Exhaust Gas”, issued on Apr. 13, 1993, to M. Funabiki et al, discloses a catalyst composition comprising a refractory support having deposited thereon an active layer containing a palladium and rhodium catalytic metal component dispersed on alumina, a cerium compound, a strontium compound, and a zirconium compound. (See the Abstract.)

U.S. Pat. No. 5,874,057, “Lean NOₓ Catalyst/Trap Method”, issued on Feb. 23, 1999 to M. Deeba et al and discloses a method of NOₓ abatement utilizing a composition comprising a NOₓ abatement catalyst comprising platinum and, optionally, at least one other platinum group metal catalyst which is kept segregated from a NOₓ sorbent material. The NOₓ sorbent material may be one or more of oxides, carbonates, hydroxides and mixed oxides of one or more of various alkali metals including lithium, sodium and potassium, and alkaline earth metals including magnesium, calcium, strontium and barium. As set forth at column 6, line 18 et seq of the '057 Patent, a platinum catalytic component is deemed to be essential and the utilization of the NOₓ sorbent material in bulk form is taught as being advantageous. The '057 Patent also teaches the optional use of ceria, for example, bulk ceria (ceria in fine particulate form), as a component of the composition. See column 3, lines 43-44.

U.S. Pat. No. 5,376,610, “Catalyst For Exhaust Gas Purification and Method For Exhaust Gas Purification”, issued on Dec. 27, 1994 to T. Takahata et al, discloses a catalyst comprising a three-way conversion catalyst followed by a hydrocarbon oxidation catalyst and designed to provide a means for hydrocarbon conversion at cold start and stable three-way conversion (of hydrocarbons, carbon monoxide and nitrogen oxides) at operating conditions. The total amount of noble metal(s) used is 20 to 80 g/ft³ in the first (three-way conversion) layer (column 5, lines 12-14) and comprises rhodium (column 4, lines 28-35), but may also include platinum and palladium, as well as base metal catalysts. The second, hydrocarbon catalyst layer, contains either platinum or palladium or both in the amount of 5 to 50 g/ft³. Palladium is stated to be preferred, but a content of more than 50 g/ft³ is stated to be inimical to the reduction of NO to N₂ (see column 5, lines 21-39). Second and third catalysts are described in column 7, lines 17-65, and at lines 60-62, the use of a total amount of palladium of 5 to 60 g/ft³ is noted. The palladium is said to be particularly effective for hydrocarbon conversion at low temperatures (column 7, lines 26-32) and is preferably disposed in the outer layer. U.S. Pat. No. 5,376,610 does not suggest the use of a NOₓ sorbent and discloses a catalyst for three-way conversion suitable for stoichiometric operation. The introduction of secondary air is used to provide a lean exhaust only during cold start-up. For example, see the Abstract.

Prior art catalysts as described above have a problem in practical application, particularly when the catalysts are aged by exposure to high temperatures and lean operating conditions, because after such exposure, such catalysts show a marked decrease in catalytic activity for NOₓ reduction, particularly at low temperature (250 to 350° C.) and high temperature (450 to 600° C.) operating conditions.

### SUMMARY OF THE INVENTION

In accordance with the present invention there is provided a catalytic trap for conversion of NOₓ in an exhaust gas stream, which trap comprises a catalytic trap material comprising (i) a refractory metal oxide support having dispersed thereon at least a palladium catalytic component in the amount of at least 25 g/ft³ Pd, e.g., from 25 g/ft³ to about 300 g/ft³ Pd; (ii) a NOₓ sorbent comprising one or more basic oxygenated compounds of one or more metals selected from the group consisting of alkali metals and alkaline earth metals. The catalytic trap material may optionally further comprise a catalytically effective amount, e.g., from 0.1 to 90 g/ft³, of a platinum catalytic component, and may optionally further comprise a catalytically effective amount, e.g., from about 0.1 to 50 g/ft³, of a rhodium catalytic component. The catalytic trap material is coated on a refractory carrier member.

In one aspect of the present invention, a palladium catalytic component may be present in the amount of from about 50 to about 300 g/ft³ Pd.

In another aspect of the present invention the NOₓ sorbent may be one or more of basic oxygenated compounds of lithium, sodium, potassium, cesium, magnesium, calcium, strontium and barium; in another aspect of the present invention the NOₓ sorbent is present in the amount of from about 0.1 to 2.5 g/in³, e.g., from about 0.25 to 1.5 g/in³.

In a related aspect of the present invention, the NOₓ sorbent may comprise basic oxygenated compounds of one or both of cesium and potassium present in the total amount of at least about 0.1 g/in³, e.g., about 0.1 to 1.5 g/in³; for example, from 0.25 to 0.9 g/in³. In a specific embodiment, the NOₓ sorbent may comprise a basic oxygenated compound of cesium present in the amount of about 0.1 to 1.5 g/in³ and, optionally, a basic oxygenated compound of barium.

One aspect of the invention provides that the catalytic trap material is carried on a carrier member in at least two discrete washcoat layers, e.g., in two discrete layers, and substantially all the palladium catalytic component is disposed in one layer and substantially all the platinum and/or rhodium catalytic component is disposed in the other layer. For example, the palladium catalytic component may be disposed in the top (or topmost) discrete layer, and a platinum and/or rhodium catalytic component may be disposed in the bottom (or inner) layer. Without wishing to be bound thereby, it is believed that in some circumstances the palladium and platinum may, if not segregated, react with each other or with other components in a manner which may be detrimental to catalytic performance. This may not be true in all circumstances and non-segregated palladium- and platinum-containing compositions are not excluded from the invention.

In another aspect of the present invention, the carrier member has a longitudinal axis and a plurality of parallel gas-flow passages extending longitudinally therethrough from a front face to a rear face of the carrier member, the gas-flow passages being defined by walls on which the catalytic NOₓ sorbent is coated. The NOₓ sorbent comprises basic oxygenated compounds of one or both of cesium and potassium disposed only in a rear segment of the carrier member defined between the rear face of the carrier member and an intermediate point along the longitudinal axis thereof. Accordingly, basic oxygenated compounds of cesium and potassium are excluded from a front segment of the carrier member defined between the front face of the carrier member and the said intermediate point. In a related aspect of the invention, the distance from the front face of the carrier to the intermediate point comprises from about 20 percent to 80 percent of the length of the carrier along its longitudinal axis.

A method aspect of the present invention provides for manufacturing a catalytic trap for conversion of NOₓ in an exhaust gas stream by practicing the following steps. In order to prepare a catalytic trap material, a palladium catalytic component is dispersed onto a refractory metal oxide support in the amount of at least 25 g/ft³ Pd, by impregnating the support with a solution of a precursor palladium compound in a liquid vehicle to provide a supported palladium catalytic component which is combined with a NOₓ sorbent comprising one or more basic oxygenated compounds of one or more metals selected from the group consisting of alkali metals and alkaline earth metals. The catalytic trap material is coated onto a refractory carrier member and the resulting coated refractory member is dried and then heated.

In another method aspect of the present invention, the catalytic trap material is coated onto the refractory carrier member in at least two layers, and substantially all of the palladium catalytic component present is dispersed in one layer, e.g., the top layer, and substantially all the platinum catalytic component present is dispersed in the other layer, e.g., the bottom layer.

The basic oxygenated compounds may be compounds of one or more of lithium, sodium, potassium, cesium, magnesium, calcium, strontium and barium, preferably compounds of one or more of sodium, potassium, cesium, calcium, strontium and barium, most preferably cesium or cesium plus barium.

Another aspect of the invention provides for carrying out the step of combining the NOₓ sorbent with the support by impregnating the support with a solution of one or more precursors of one or more of the basic oxygenated metal compounds and drying and heating the impregnated support to decompose the one or more precursors to the NOₓ sorbent. In a related aspect of the invention, the step of impregnating the support with the precursor palladium compound and thereafter drying and heating the impregnated support is carried out prior to the step of impregnating the support with the one or more precursor compounds of the NOₓ sorbent.

In a preferred method of the present invention, the NOₓ sorbent, or a portion thereof, is incorporated into the catalytic material by a “post-dipping technique” in which a dried and heated, e.g., calcined, washcoat containing the palladium catalytic component (and optionally other components) is dipped into a solution of one or more NOₓ sorbent precursor compounds. Specifically, the post-dipping technique is carried out by the steps of (i) coating the supported palladium catalytic component onto the refractory carrier member; (ii) drying and heating the resulting coating to provide a palladium catalytic washcoat; (iii) after step (ii), dipping the carrier member into a solution of one or more NOₓ precursor compounds to impregnate the one or more NOₓ precursor compounds into the palladium catalytic washcoat; and (iv) drying and heating the dipped carrier member obtained from step (iii) to decompose the one or more NOₓ precursor compounds into the NOₓ sorbent.

In another method aspect of the present invention, the basic oxygenated compounds of one or both of cesium and potassium are disposed only between the rear face of the carrier member and an intermediate point along the longitudinal axis thereof, whereby basic oxygenated compounds of cesium and potassium are excluded from between the front face of the carrier member and the said intermediate point.

Yet another aspect of the present invention provides a method of treating an exhaust gas stream comprising the steps of contacting the stream with the catalytic trap as described above under alternating periods of (1) lean and (2) stoichiometric or rich operation. The contacting is carried out at conditions whereby at least some of the NOₓ in the exhaust gas stream is trapped in the catalytic material during the periods of lean operation and is released and reduced to nitrogen during the periods of stoichiometric or rich operation.

In a related aspect of the invention, there is provided a method of treating an exhaust gas which contains hydrocarbons, the method comprising catalytically treating the exhaust gas to oxidize hydrocarbons contained therein prior to contacting the exhaust gas with the catalytic trap.

Reference herein and in the claims to “component” or “components” with reference to catalytic components such as palladium, platinum or rhodium catalytic components means the metal in catalytically effective form, e.g., as the element. Similarly, reference herein and in the claims to metal “components” comprising NOₓ sorbents means any effective NOₓ-trapping forms of the metals, e.g., oxygenated metal compounds such as metal hydroxides, mixed metal oxides, metal oxides or metal carbonates.

The quantities of components of the catalytic material are expressed herein in units of weight per unit volume, specifically, grams per cubic inch (“g/in³”) and grams per cubic foot (“g/ft³”). This system of nomenclature accommodates voids in a carrier member such as the carrier member having a plurality of parallel, fine gas-flow passages extending therethrough, on the walls of which the catalytic NOₓ sorbent is coated. The nomenclature would similarly accommodate the voids contained in an embodiment wherein the catalytic NOₓ sorbent is coated onto beads of a catalytically inert material, the inert beads and the interstices between them providing voids in the catalytic trap. Concentrations (“loadings”) in the trap member of catalytic metals such as Pd, Rh and Pt are given on the basis of the elemental metal and are expressed as, e.g., 200 g/ft³ Pd, 90 g/in³ Pt, etc. Loadings of NOₓ sorbents are similarly given on a weight per volume basis, but as grams per cubic inch (“g/in³”), and calculated on the basis of the following oxides: Li₂O, Na₂O, K₂O, Cs₂O, MgO, CaO, SrO and BaO. The coating of the catalytic NOₓ sorbent on the carrier member is sometimes referred to as a “washcoat” because the carrier member is typically coated with an aqueous slurry of particles of the solids, e.g., the refractory metal oxide support, and the slurry coating is then dried and heated (calcined) to provide the washcoat.

Reference herein and in the claims to the use of “dispersions” or the like of precursor compounds in a liquid includes the use of solutions or other dispersions in a liquid vehicle of precursor compounds and/or complexes.

As used herein and in the claims, an “oxygenated metal compound” means a compound of metal and oxygen which may or may not contain other elements. For example, the basic oxygenated metal compounds may comprise one or more of a metal oxide, a metal carbonate, a metal hydroxide or a mixed metal oxide such as barium zirconate.

In all cases, the heating may be at a temperature high enough, and otherwise under conditions sufficient to help fix onto the carrier member the washcoat resulting from the heating and to decompose at least some of any precursor compounds utilized. For example, the heating may be carried out in air at a temperature of 450° C. or higher, e.g., 550° C. Heating under the latter conditions is sometimes referred to as “calcining”.

### BRIEF DESCRIPTION OF THE DRAWINGS

FIG. 1 is a perspective view of a catalytic trap comprising a single honeycomb-type refractory carrier member in accordance with one embodiment of the present invention;

FIG. 1A is a partial cross-sectional view enlarged relative to FIG. 1 and taken along a plane parallel to the end faces of the carrier of FIG. 1;

FIG. 1B is a view, enlarged relative to FIG. 1A, of one of the gas-flow passages shown in FIG. 1A;

FIGS. 2A and 2B are schematic representations of two steps in the manufacture of a catalytic trap in accordance with a specific embodiment of the present invention;

FIG. 3 is a perspective view of a second catalytic trap comprising two discrete honeycomb-type refractory carrier members in accordance with a second embodiment of the invention;

FIG. 4 is a schematic representation of a treatment system for an engine exhaust comprising an optional pretreatment catalyst disposed upstream of a catalytic trap in accordance with the present invention;

FIGS. 5-12 are graphs of “NOₓ conversion curves” obtained by plotting on the vertical axis the percent of NOₓ in the inlet stream to the test catalytic trap which is converted to N₂, by being contacted with the catalytic trap, and on the horizontal axis the temperature in degrees centigrade of the inlet stream immediately prior to its entering the catalytic trap;

FIG. 13 is a graph of “hydrocarbon conversion curves” obtained by plotting on the vertical axis the percent of hydrocarbons (“HC”) in the inlet stream to the test catalytic trap which is converted (primarily to CO₂ and H₂O) by being contacted with the catalytic trap, and on the horizontal axis the temperature in degrees centigrade of the inlet stream immediately prior to its entering the catalytic trap; and

FIG. 14 is a graph of the NOₓ conversion curves for the tests in which the hydrocarbon conversion curves of FIG. 13 were generated.

### DETAILED DESCRIPTION OF THE INVENTION AND SPECIFIC EMBODIMENTS THEREOF

The reduction of NOₓ from the exhaust of lean-burn engines, such as gasoline direct injection and partial lean-burn engines, as well as from diesel engines, requires trapping of NOₓ at lean engine operating conditions and releasing and reducing the NOₓ at stoichiometric or rich engine operating conditions. The lean operating cycle is typically between 1 to 3 minutes and the rich operating cycle should be small enough (1 to 5 seconds) to preserve as much as possible of the fuel benefit associated with lean-burn engines.

A catalytic trap generally must provide a NOₓ trap function and a catalyst function, typically a TWC catalyst function. Without wishing to be bound by a particular theory, it is believed that catalytic traps function in the following manner.

1) At lean engine operating conditions the following reactions are promoted.

(a) NO+½ O₂→NO₂

(b) NO₂+NOₓ sorbent→Trap nitrate, e.g., Ba(NO₃)₂, when barium oxide is the NOₓ sorbent.

Reaction (a) is typically promoted by palladium and/or platinum catalytic components. The NOₓ sorbent in reaction (b) is typically an oxide of, e.g., Na, K, Sr, Ba, etc.

2) At stoichiometric or rich engine operating conditions the following reactions are promoted.

(c) Trap Nitrate→NOₓ sorbent+NO*

(d) NO*+CO, HC, or H₂→N₂+H₂O+CO₂

Reaction (d) is typically promoted by palladium and/or rhodium catalytic components.

Generally, as shown in test data reported below, conventional catalytic traps used in treating NOₓ emitted from lean-burn engines showed severe loss in NOₓ activity at temperatures of 200-350° C. after lean or fuel-cut aging at temperatures greater than 650° C. (Fuel-cut aging of a catalytic trap takes place when the flow of fuel to an engine whose exhaust is being treated by the catalytic trap is temporarily cut off, thereby providing extremely lean operating conditions during the fuel cut-off period of operation.) For example, NOₓ conversion for fresh conventional catalytic traps measured at 300° C. dropped from over 90% to less than 30% after lean aging at 750° C. In contrast, catalytic traps in accordance with the present invention showed much better catalyst durability after similar lean aging. The catalytic traps of the present invention retained high NOₓ conversions between 250 and 350° C. after lean aging at 750° C. by the expedient of using high palladium catalyst concentrations, specifically, concentrations of at least about 25 g/ft³ Pd, e.g., up to about 300 g/ft³ Pd (measured as the elemental metal). Such retention of activity is a great advantage over the prior art and may be attained by adding to a combination of a known TWC catalyst with known NOₓ sorbents high concentrations, at least about 25 g/ft³ Pd, of a palladium catalyst. For example, the palladium concentration may be at least about 25 or 30 g/ft³, at least about 50 g/ft³, e.g., more than 50 g/ft³ or more than 60 g/ft³, up to about 250 or 300 g/ft³, including any concentration lying within the stated broad range. At concentrations or loadings below about 25 g/ft³ the benefit of enhanced durability is not significantly attained, and at very high loadings, e.g., above 250 or 300 g/ft³, the added cost does not provide a commensurate benefit. Generally, the improvement in durability of the catalyst traps of the invention was found to be enhanced with increasing Pd concentration, which improved hydrothermal stability of the catalyst trap and enhanced the durability of low temperature NOₓ conversion capability. Significant improvements in durability were attained in catalytic traps wherein the washcoat of the present invention was present in both single-layer and multiple-layer, e.g., two-layer, versions. In the multiple-layer versions, in one preferred embodiment the palladium catalytic component is contained in the topmost layer. In another preferred embodiment, when optional platinum, or platinum plus rhodium catalytic components are included in the composition, the palladium catalytic component is segregated from the platinum or rhodium catalytic components. Such segregation is readily attained, for example, by placing substantially all the palladium catalytic component into one discrete layer of washcoat and by placing substantially all the platinum and/or rhodium catalytic components in a separate discrete layer of washcoat. Segregation of the palladium and platinum/rhodium catalytic components may be attained by impregnating one batch of refractory metal oxide support with the palladium catalytic component, and impregnating a second batch of refractory metal oxide support with the platinum and/or rhodium catalytic components, and then mixing the two batches of impregnated support into a single layer. A higher degree of segregation is, however, attained by placing the palladium and platinum/rhodium catalytic components into respective separate, discrete layers.

The NOₓ sorbents can be incorporated into the catalytic trap material of the present invention in any suitable manner. Thus, the NOₓ sorbent may be introduced in bulk particle form simply by mixing particles of the NOₓ sorbent component with the particles of refractory metal oxide support on which the palladium and/or optional platinum and rhodium catalytic components are dispersed. Alternatively, the NOₓ sorbent may be dispersed on its own refractory metal oxide support by impregnating suitable refractory metal oxide particles with a solution of a precursor compound of the NOₓ sorbent, drying and heating in air or other oxygen-containing gas (calcining). The resultant supported NOₓ sorbent may be incorporated into the washcoat by admixing the particles with the supported catalytic component particles in a slurry to be applied as a washcoat to a carrier member. Alternatively, the supported NOₓ sorbent particles may be applied as a separate, discrete layer of the washcoat. Alternatively, and preferably, with respect to attaining finer dispersion of the NOₓ sorbent throughout the catalytic trap material, the NOₓ sorbent can be dispersed in the washcoat by impregnating a palladium-containing, calcined refractory metal oxide particulate support (which may also contain optional platinum and/or rhodium catalytic components) with a solution of a soluble precursor compound of the NOₓ sorbent metal, e.g., a nitrate or acetate such as cesium nitrate, and then drying and calcining the impregnated support in air (or other oxygen-containing gas) to decompose the impregnated precursor compound to the NOₓ sorbent. This technique may advantageously be used by dipping a carrier member having thereon a calcined washcoat containing the palladium and optional platinum and/or rhodium catalytic components into a solution of one or more precursor compounds of the NOₓ sorbent. It will be appreciated that different portions of the NOₓ sorbent may be incorporated into the catalytic trap material by different ones of the above techniques. The choice of a particular method of incorporation of the NOₓ sorbent may in some cases by dictated by the particular components being utilized. For example, if both cesium and magnesium NOₓ sorbents are to be utilized in the same composition, precursor compounds of cesium and magnesium should not be present in the same solution because at least some such compounds tend to react with each other and form a precipitate.

Despite the teachings of the prior art, such as U.S. Pat. No. 5,473,887 discussed above, it has been found that the use of rare earth metal in the NOₓ sorbents is preferably eliminated or at least minimized. This is because rare earth metals, such as ceria, when oxidized during lean operations, tend to become reduced during rich or stoichiometric operations, thereby releasing oxygen which will react with and consume some of the hydrogen, hydrocarbons and CO which are needed to react with NOₓ in order to reduce the NOₓ to nitrogen. Therefore, preferably, no or only very limited amounts of rare earth metal oxides such as ceria are included in the catalytic trap materials of the present invention. For example, minor amounts of ceria or other rare earth metal oxides used in the known manner to thermally stabilize alumina or other refractory metal oxides do not substantially adversely affect NOₓ conversion of the compositions of the present invention.

The NOₓ sorbent of the present invention thus comprises a basic oxygenated compound (including, without limitation, an oxide, carbonate, hydroxide or mixed metal oxide) of one or more of lithium, sodium, potassium, cesium, magnesium, calcium, strontium and barium. The mixed oxides may be, for example, barium zirconate, calcium titanate, barium titanate, magnesium titanate (e.g., MgO.TiO₂), magnesium alumina titanate (e.g., MgO.Al₂O₃), etc.

It has been found that in order to provide durable high temperature (450 to 600° C.) activity for NOₓ reduction, the NOₓ sorbent should comprise one or both of cesium or potassium basic oxygenated compounds present in the amounts indicated above, that is, at least about 0.1 g/in³, e.g., about 0.1 to 1.5 g/in³. Preferably, the above-noted total loading of NOₓ sorbent of from 0.1 to 2.5 g/in³ includes a total loading of cesium and/or potassium oxygenated compounds of from about 0.1 to 1.5 g/in³.

It is known that catalytic trap materials are susceptible to sulfur poisoning and that at regular intervals during use, depending on factors such as the sulfur levels in the fuel whose exhaust is being treated by the catalytic trap material, the trap material must be de-sulfated, typically once in every 200 to 1000 miles (322 to 1,609 kilometers) of engine operation. De-sulfation is attained by a period, e.g., three to five minutes, of rich operation at high temperature. For example, three to five minutes of operation of the catalytic trap at 650° C. at λ=0.990 to 0.995 will desulfate the catalyst trap material, where X is the ratio of actual to stoichiometric air-to-fuel weight ratios. It follows that λ=1 indicates a stoichiometric mixture, λ>1 indicates a lean mixture and λ<1 indicates a rich mixture.

As indicated above, it has been found that in the catalytic trap material of the present invention, the presence of cesium and/or potassium oxygenated compounds as the NOₓ sorbent provides enhanced high-temperature NOₓ conversion. It is, however, conventional wisdom that such cesium and potassium compounds are difficult to desulfate, and so there has been resistance to utilizing them as a component of the NOₓ sorbent, at least in amounts sufficient to enhance high-temperature NOₓ reduction. Surprisingly, it has been found that cesium is much easier to de-sulfate than is potassium and is generally no more difficult than the other NOₓ sorbent materials of the present invention to de-sulfate. To this extent, therefore, a basic oxygenated compound of cesium, present in an amount of from about 0.1 to 1 g/in³, e.g., from about 0.1 to 0.7 g/in³, is a preferred NOₓ sorbent.

The front longitudinal portion of the catalytic trap (the portion end to which the exhaust stream being treated is first introduced) preferably excludes the cesium and potassium NOₓ sorbents, which, when used, are relegated to a rear portion of the catalytic trap. For example, a typical so-called honeycomb-type carrier member comprises a “brick” of material such as cordierite or the like, having a plurality of fine, gas-flow passages extending therethrough from the front face to the rear face of the carrier member. These fine gas-flow passages, which may number from about 100 to 900 passages or cells per square inch of face area (“cpsi”), have a catalytic trap material coated on the walls thereof. It is preferred to relegate any cesium or potassium NOₓ sorbent utilized to the rear longitudinal segment of the carrier member so as not to reduce the activity of the front longitudinal segment of the carrier member for the oxidation of hydrocarbons. Typically, the first 20 to 80 percent of the longitudinal length of the carrier member is kept substantially free of the cesium and potassium NOₓ sorbents which are relegated to the rear 20 to 80 percent of the length of the catalytic trap. The same effect may be attained by using two separate carrier members in series, the first or upstream member being devoid of cesium or potassium-based NOₓ sorbents, which may be contained in a second or downstream carrier member.

The catalytic trap material of the present invention may contain other suitable components such as base metal oxide catalytic components, e.g., oxides of one or more of nickel, manganese and iron. Such components are useful at least because of their ability to trap hydrogen sulfide at rich or stoichiometric conditions and, at lean conditions, to promote the oxidation of hydrogen sulfide to sulfur dioxide. The level of released SO₂ is relatively small, and in any case, it is less obnoxious than the release of H₂S, because of the pungent unpleasant odor of the latter. Such components, when employed, are preferably disposed at the rear or downstream end of the catalytic trap so that the SO₂ formed will not contact the entire length of the trap. The SO₂ has a tendency to poison the catalyst and, if disposed in the downstream section of the catalytic trap, most of it will be discharged from the catalytic trap and any poisoning of the catalyst will be limited. Preferably, such components are placed within the downstream 20% of the longitudinal length of the catalytic trap. (The term “downstream” is used as sensed by the exhaust flowing through the catalytic trap.)

The palladium catalytic component is dispersed onto the refractory metal oxide support in the amount of from more than 50 g/ft³ to about 300 g/ft³ Pd and one or both of (1) a catalytically effective amount of a platinum catalytic component and (2) a catalytically effective amount of a rhodium catalytic component may be used.

The palladium and optional platinum and rhodium catalytic components are supported on a suitable refractory metal oxide support, and are prepared by techniques well known in the art, e.g., by impregnating the support with a precursor compound or complex of the catalytic metal. Although the present invention contemplates the use of high concentrations (more than 50 g/ft³) of palladium as the sole precious metal catalytic component, useful results are obtained by including one or both of platinum and rhodium catalytic components in the composition. For example, in at least some cases, the percentage conversion of NOₓ is enhanced by combining more than 50 g/ft³ of palladium with a platinum catalytic component. For example, a catalytic trap in accordance with the present invention containing 120 g/ft³ palladium plus 30 g/ft³ of platinum has been found to provide higher (up to about 90%) rates of conversion of NOₓ than are obtained by the use of 150 g/ft³ of palladium, which under comparable test conditions attained an 80 to 85% conversion of NOₓ.

Any suitable loadings of the optional platinum and rhodium catalytic components may be used, e.g., from 1, 5, 10, 15 or 20 g/ft³ of either platinum or rhodium, up to, e.g., 30, 40 or 50 g/ft³ rhodium and up to, e.g., 70, 80 or 90 g/ft³ platinum.

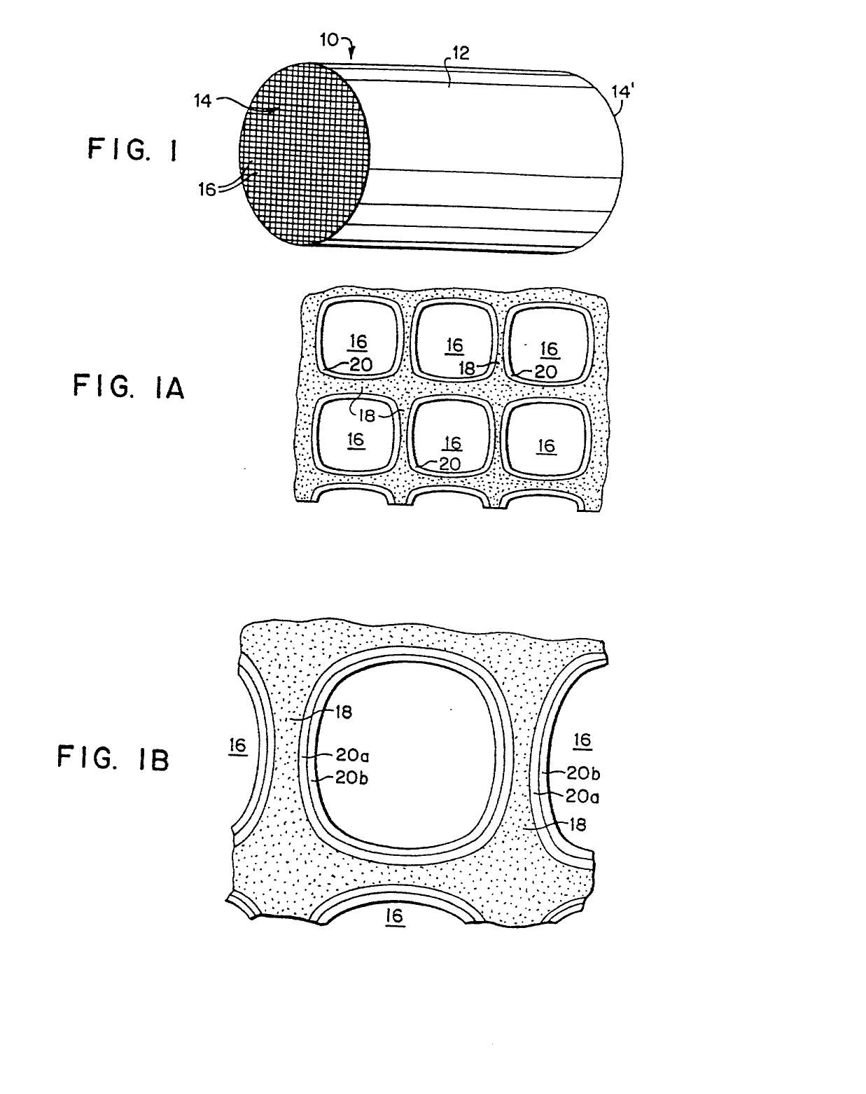

FIG. 1 shows generally at 10 a catalytic trap comprising refractory carrier member 12 of generally cylindrical shape having a cylindrical outer surface, one end face comprising a front face 14 and an opposite end face comprising a rear face 14′, which is identical to front face 14. (In FIG. 1 there is visible only the junction of outer surface 12 with the rear face 14′ at its peripheral edge portion. Further, there is omitted from FIG. 1 the usual canister within which catalytic trap 10 would be enclosed, the canister having a gas stream inlet at front face 14 and a gas stream outlet at rear face 14′.) Carrier member 10 has a plurality of fine, parallel gas-flow passages 16 formed therein, better seen in enlarged FIG. 1A. Gas-flow passages 16 are formed by walls 18 and extend through carrier 10 from front face 14 to the opposite rear face 14′ thereof, the passages 16 being unobstructed so as to permit the flow of, e.g., an exhaust stream, longitudinally through carrier 10 via gas-flow passages 16 thereof. As will be seen from FIGS. 1A and 1B, walls 18 are so dimensioned and configured that gas-flow passages 16 have a substantially regular polygonal shape, substantially square in the illustrated embodiment, but with rounded corners in accordance with U.S. Pat. No. 4,335,023, issued Jun. 15, 1982 to J. C. Dettling et al. Of course, gas-flow passages of any suitable cross-sectional shape, square, circular, hexagonal, etc., may be used. A layer 20, which in the art and sometimes below is referred to as a “washcoat”, is adhered to the walls 18 and, as shown in FIG. 1B, may be comprised of a single layer comprising the catalytic NOₓ sorbent. Alternatively, as illustrated in FIG. 1B, layer or washcoat 20 may comprise a first discrete layer or bottom layer 20a and a second discrete layer or top layer 20b superposed over bottom layer 20a. For purposes of illustration, the thickness of layers 20, 20a and 20b are exaggerated in FIG. 1A and 1B.

As shown in FIGS. 1-1B, the honeycomb-type carrier members include void spaces provided by the gas-flow passages, and the cross-sectional area of these passages and the thickness of the walls defining the passages will vary from one type of carrier member to another. Similarly, the weight of washcoat applied to such carriers will vary from case to case. Consequently, in describing the quantity of washcoat or catalytic component or other component of the composition, it is convenient, as noted above, to use units of weight of component per unit volume of catalyst carrier. Therefore, the units grams per cubic inch (“g/in³”) and grams per cubic foot (“g/ft³”) are used herein to mean the weight of a component per volume of the carrier member, including the volume of void spaces of the carrier member.

A typical method of manufacturing a catalytic trap in accordance with the present invention is to provide the catalytic NOₓ sorbent as a coating or layer of washcoat on the walls of the gas-flow passages of a suitable refractory carrier member such as a cordierite honeycomb carrier. This may be accomplished, as is well known in the art, by impregnating a fine particulate refractory metal oxide, e.g., activated alumina (high surface area, predominately gamma alumina), with one or more catalytic metal components essentially including palladium and optionally including platinum and/or rhodium, drying and calcining the impregnated activated alumina particles and forming an aqueous slurry of these particles. Any other suitable refractory metal oxide support may be used, e.g., silica, titania, zirconia, baria-zirconia, ceria-zirconia, lanthana-zirconia, titania-zirconia and ceria-alumina. (The small amounts of ceria in ceria-stabilized supports is not unduly detrimental to functioning of the catalyst trap material of the present invention.) Particles of a bulk NOₓ sorbent may be included in the slurry. Alternatively, the NOₓ sorbent may be dispersed into the support, preferably in a post-dipping operation, as described above. The activated alumina may have initially been thermally stabilized, as is well known in the art, by impregnating it with, for example, a solution of a soluble salt of barium, lanthanum, rare earth metal or other known stabilizer precursor, and calcining the impregnated activated alumina to form a stabilizing metal oxide dispersed onto the alumina. Base metal catalysts may optionally also have been impregnated into the activated alumina, for example, by impregnating a solution of nickel nitrate into the alumina particles and calcining to provide nickel oxide dispersed in the alumina particles.

The carrier member may then be immersed into the slurry of impregnated activated alumina and excess slurry removed to provide a thin coating of the slurry on the walls of the gas-flow passages of the carrier. The coated carrier is then dried and calcined to provide an adherent coating of the catalytic component and, optionally, the NOₓ trap component, to the walls of the passages thereof. The carrier may then be immersed into a slurry of fine particles of a basic oxygenated metal compound, for example, in an aqueous slurry of fine particles of bulk strontium oxide, to provide a second or top coating (layer) of a NOₓ sorbent deposited over the first or bottom coating of NOₓ catalyst. The coated carrier member is then dried and calcined to provide a finished catalyst composition in accordance with one embodiment of the present invention.

Alternatively, the alumina or other support particles impregnated with the catalytic component may be mixed with bulk or supported particles of the NOₓ sorbent in an aqueous slurry, and this mixed slurry of catalytic component particles and NOₓ sorbent particles may be applied as a coating to the walls of the gas-flow passages of the carrier member. Preferably, however, for improved dispersion of the NOₓ sorbent, the washcoat of catalytic component material, after being dried and calcined, is immersed (post-dipped) into a solution of one or more precursor compounds (or complexes) of NOₓ sorbent to impregnate the washcoat with the NOₓ sorbent precursor. The impregnated washcoat is then dried and calcined to provide the NOₓ sorbent dispersed throughout the washcoat.

Separate, discrete layers of washcoat may be applied in successive impregnating/drying/calcining operations, e.g., to provide a bottom washcoat layer containing, e.g., substantially all of the optional platinum catalytic component and a top washcoat layer containing, e.g., substantially all of the palladium catalytic component. Alternatively, substantially all the palladium catalytic component may be contained in the bottom washcoat layer and substantially all the platinum catalytic component may be contained in the top layer. In a third variation, platinum and palladium catalytic components, or portions thereof, may be contained in both the top and bottom layers of washcoat. A rhodium catalytic component may supplement or replace the platinum catalytic component in any of the above combinations. Further, more than two washcoat layers may be provided. The NOₓ sorbent may be dispersed by impregnation into, e.g., both the top and bottom layers.

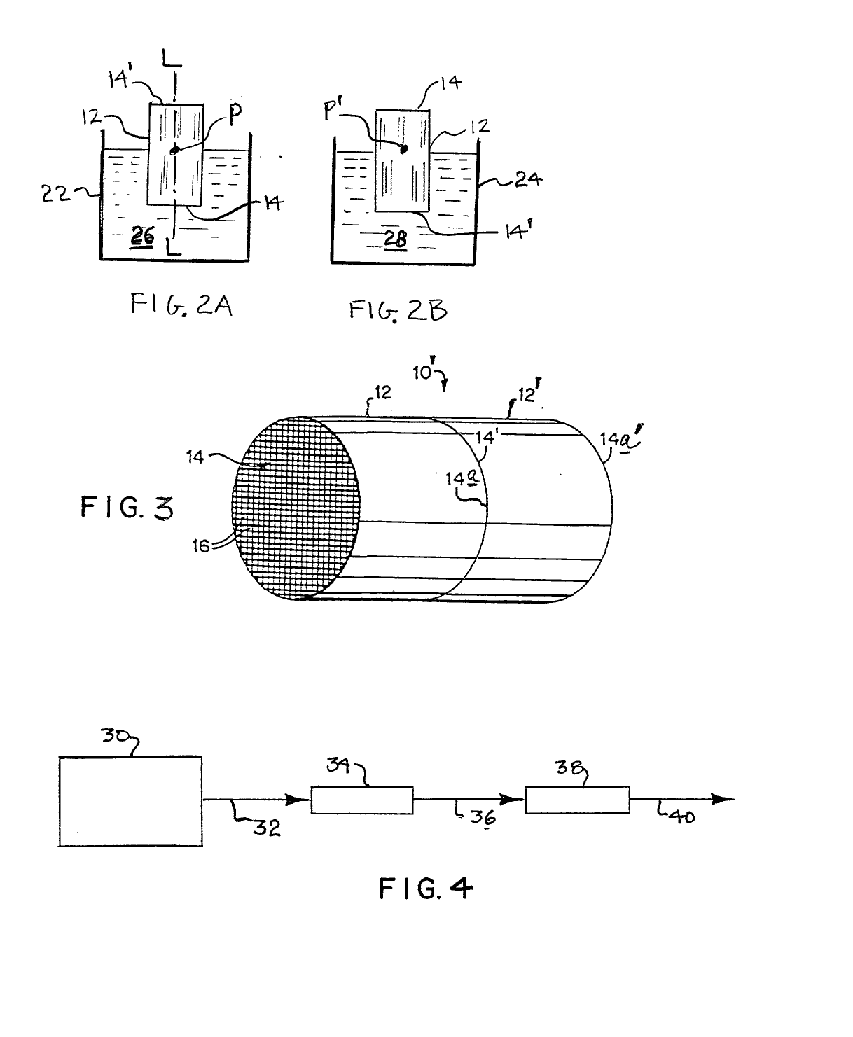

FIGS. 2A and 2B illustrate sequential steps in a method of post-dipping to provide the NOₓ sorbent dispersed onto the refractory metal oxide support with the front segment (between front face 14 and an intermediate point along the longitudinal axis of the carrier member 12) free of cesium and potassium-based NOₓ sorbents, which are relegated to a rear segment (between rear face 14′ and the intermediate point) of the carrier member. FIG. 2A shows a tank 22 within which is disposed a solution 26 of one or more NOₓ sorbent precursor compounds, excluding potassium and cesium compounds, and FIG. 2B shows a tank 24 within which is dispersed a solution 28 of one or more NOₓ sorbent precursor compounds, including one or both of cesium and potassium precursor compounds.

In FIG. 2A, a carrier member 12, which already has thereon a calcined washcoat comprising the palladium catalytic component dispersed on a metal oxide support, is dipped, front face 14 first and rear face 14 uppermost, within solution 26 with the longitudinal axis L-L of carrier member 12 maintained substantially vertically. Carrier member 12 is dipped within solution 26 only to a depth defined by the point P along the longitudinal axis L-L. After dipping, carrier member 12 is removed from solution 26 and dried. The dipping and drying may be repeated as many times as needed until the desired loading of the alkaline earth metal component precursor compound is attained.

In one embodiment, care is taken not to contact the solution 26 with the longitudinal segment of the carrier member 12 between point P and rear face 14′. In another embodiment, the entirety of carrier member 12 may be dipped within solution 26 so as to apply the precursor NOₓ sorbent compounds along the entire length of the gas-flow passages 16 of carrier member 12. After completion of the dipping step or steps illustrated in FIG. 2A, carrier member 12 is dipped within solution 28 in tank 24 (FIG. 2B) with front face 14 uppermost and rear face 14′ submerged below the surface of solution 28. Carrier member 12 is dipped within solution 28 only to a depth indicated by the point P′ along the longitudinal axis (not shown in FIG. 2B) of carrier member 12. Care is taken not to contact the solution 28 with the longitudinal segment of the carrier member 12 between point P′ and front face 14 so as to avoid applying any cesium or potassium precursor compounds between point P′ and front face 14. Point P′ may be at the identical point along the longitudinal axis L-L as point P, or point P′ may be located between point P and rear face 14′ so as to provide an intermediate section of carrier member 12 wherein the NOₓ sorbent precursor of both solutions 26 and 28 are present. Dipping of carrier member 12 into solution 28 may be repeated as described above with respect to the dippings of carrier member 12 into solution 26. Dippings are followed by drying and calcining.

FIG. 3 illustrates a catalytic trap 10′ comprised of two carrier members 12 and 12′ arranged in longitudinal alignment with rear face 14a of carrier member 12 juxtaposed to, e.g., in abutting contact with, front face 14′ of carrier member 12′. (In FIG. 3, only a portion of the peripheral edges of rear face 14a of carrier member 12 and front face 14′ of carrier member 12′ are visible. Further, a suitable canister having an inlet and an outlet and within which carrier members 12 and 12′ would be enclosed is omitted from FIG. 3.) In this arrangement, the exhaust being treated is flowed into carrier member 10′ via front face 14 thereof, through the gas-flow passages 16 of carrier member 12 out rear face 14a thereof and into front face 14′ of carrier member 12′. The exhaust being treated flows through the gas-flow passages (not visible in FIG. 3) of carrier member 12′ and exits from rear face 14a′ thereof. In this embodiment, any cesium and/or potassium NOₓ sorbents utilized will be relegated to carrier member 12′ and are excluded from carrier member 12.

In use, the exhaust gas stream which is contacted with the catalytic trap of the present invention is alternately adjusted between lean and stoichiometric/rich operating conditions so as to provide alternating lean operating periods and stoichiometric/rich operating periods. It will be understood that the gas stream, e.g., exhaust, being treated may be selectively rendered lean or stoichiometric/rich either by adjusting the air-to-fuel ratio fed to the engine generating the exhaust or by periodically injecting a reductant into the gas stream upstream of the catalyst. For example, the composition of the present invention is well suited to treat the exhaust of engines, including diesel engines, which continuously run lean. In such case, in order to establish a stoichiometric/rich operating period, a suitable reductant, such as fuel, may be periodically sprayed into the exhaust immediately upstream of the catalytic trap of the present invention to provide at least local (at the catalytic trap) stoichiometric/rich conditions at selected intervals. Partial lean-burn engines, such as partial lean-burn gasoline engines, are designed with controls which cause them to operate lean with brief, intermittent rich or stoichiometric conditions.

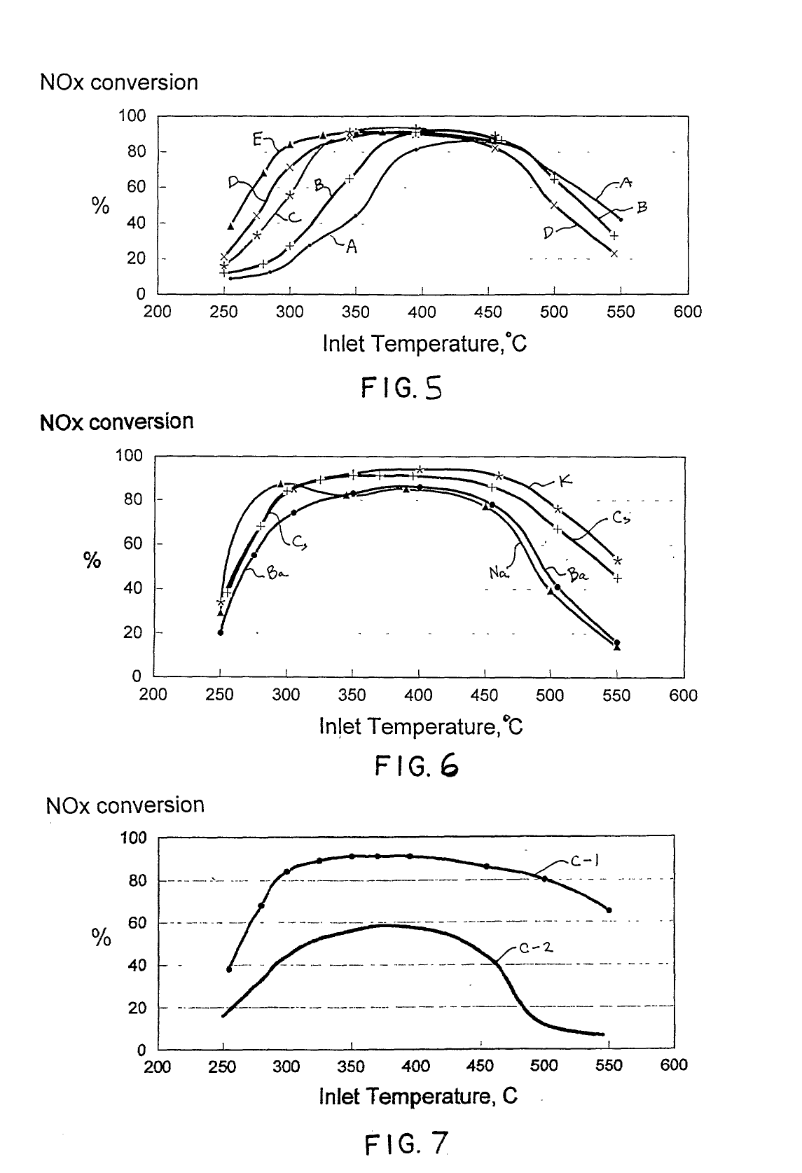

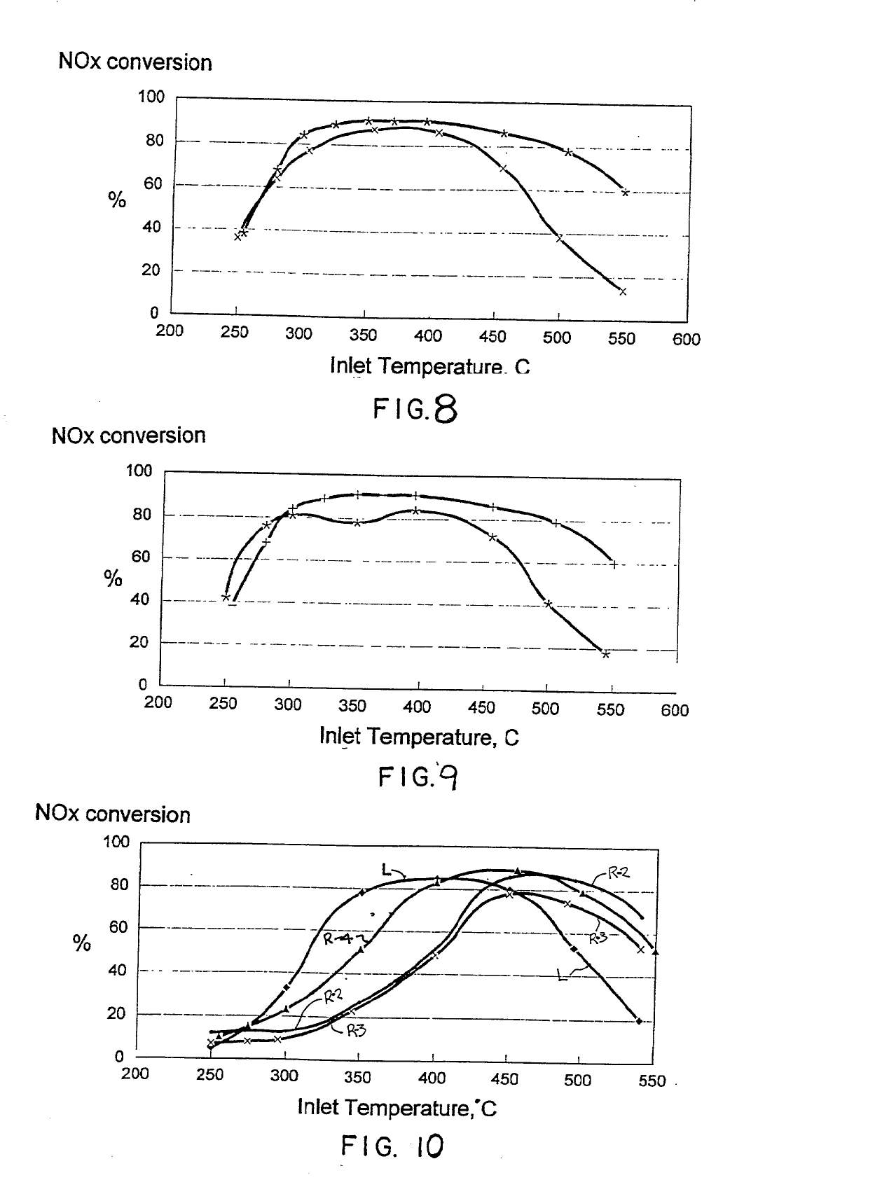

FIG. 4 schematically illustrates the utilization of a treatment system in which a pretreatment catalyst is interposed in the exhaust stream upstream of the catalytic trap of the present invention. Thus, a lean-burn or partial lean-burn engine 30 discharges its exhaust from an exhaust gas manifold (not shown) to an exhaust line 32, which introduces the exhaust into a pretreatment catalyst 34, which comprises a catalyst which is suitable to promote at least the oxidation of hydrocarbons. Catalyst 34 may comprise a conventional TWC catalyst which would typically include platinum, palladium and rhodium catalytic components dispersed on a high surface area refractory support and may optionally also contain one or more sulfur trap components such as oxides of barium, potassium, lithium, etc. Such catalysts can be stabilized against thermal degradation by well known expedients such as impregnating an activated alumina support with one or more rare earth metal oxides, e.g., ceria. Such stabilized catalysts can sustain very high operating temperatures. For example, if a fuel cut technique is utilized, temperatures as high as 950 C may be sustained in pretreatment catalyst 34. In any case, a significant portion of the hydrocarbons contained in the exhaust stream is oxidized to CO₂ and H₂O in pretreatment catalyst 34. The effluent from pretreatment catalyst 34 passes via line 36 to catalytic trap 38 in accordance with an embodiment of the present invention, wherein NOₓ is stored and then reduced during respective lean and stoichiometric operating cycles as described above. The treated exhaust stream is discharged to the atmosphere via tailpipe 40.

In the following examples, all weight percents of a given component of a combination are percent by weight, calcined basis, of the total weight of the combination, including that of the given component. Reference to, e.g., “73% of 0.56% Pt/Al₂O₃”, means that alumina particles containing 0.56% by weight Pt (weight of Pt divided by the weight of Pt plus Al₂O₃,, calcined basis, result multiplied by 100, =0.56%) comprises 73% by weight of the slurry solids (calcined basis) of which the Pt/Al₂O₃ is a part.

### EXAMPLE 1

This example provides five catalytic traps prepared by exactly the same procedures and containing exactly the same ingredients except for differences in the palladium loading, which was varied from zero to 200 g/ft³ Pd. The comparative catalytic trap sample containing no palladium is denominated Sample A; the others are denominated Sample B (Pd=50 g/ft³), Sample C (Pd=100 g/ft³), Sample D (Pd=150 g/ft³), and Sample E (Pd=200 g/ft³).

The sample catalytic traps were prepared with a two-layered washcoat, a bottom coat and a top coat. The preparation of the bottom and top coats are given below.

### A. Bottom Coat

### 1. Preparation (Pt on Al₂O₃)

Alumina powder having a surface area of about 150 square meters per gram (“m²/g”) was impregnated with a solution of platinum ammine hydroxide to give in the bottom coat of the finished catalytic trap sample a platinum loading of 60 g/ft³ Pt. Preparation was carried out by diluting the platinum-containing solution with distilled water to provide sufficient solution to bring the batch of alumina powder to incipient wetness of the alumina. Using a planetary mixer, the alumina was impregnated by slowly dripping the diluted platinum ammine hydroxide solution from a separatory funnel onto the alumina in a mixing bowl and mixing for approximately 10 to 15 minutes. The separatory funnel was rinsed with distilled water and a quantity of lanthanum nitrate equal to 5% of the weight of the alumina was dissolved in the distilled water. While still mixing the impregnated alumina with the planetary mixer, the lanthanum nitrate solution was dripped slowly from the separatory funnel onto the platinum-impregnated alumina.

2. Slurry Preparation

The impregnated alumina obtained in step 1 above was shear-mixed with distilled water (some of which was reserved for use later in the preparation) and a few drops of octanol. The remaining lanthanum-nitrate solution was added to the alumina as well as a solution of barium acetate and zirconium acetate in amounts to attain in the finished catalytic trap the following loadings of metal oxides: BaO=0.15 g/in³, ZrO₂=0.08 g/in³, and La₂O₃=0.05 g/in³. The resulting slurry was continuously milled until a particle size of 90% of the particles having a diameter of 12 microns or less was attained. A ceria-zirconia powder was added in an amount to give a loading of 0.5 g/in³ in the finished sample trap member and the reserved distilled water was added. Acetic acid (about 75 to 100 ml) was added to reduce viscosity, providing a pH of about 5 to 5.25. The slurry was continuously milled to a particle size of 90% of the particles having a diameter of 9 microns or less.

3. Coating

The properties of the slurry obtained in step 2 above were adjusted for coating by adding distilled water to lower the concentration of solids and adding acetic acid. Cylindrical cordierite substrates measuring 1.5 inches (3.8 cm) in diameter and 3 inches (7.12 cm) in length were coated with the slurry to achieve (after drying and calcining) a target bottom coat loading of 2 g/in³, including a loading of 1.25 g/in³ of Pt/Al₂O₃. The coated substrates were dried at 110° C. for 4 hours and calcined at 550° C. for 1 hour in air.

### B. Top Coat

4. Preparation of Pt on Al₂O₃

Alumina having a surface area of about 150 m²/g was impregnated with a platinum ammine hydroxide solution to give in the top coat of the finished sample a platinum loading of 30 g/ft³ Pt. Distilled water was added to provide an amount of solution sufficient to attain incipient wetness of the alumina powder. Using a planetary mixer, the alumina was impregnated with the platinum solution by slowly dripping the diluted platinum solution from a separatory funnel onto the alumina in the mixing bowl and mixing for approximately 10 to 15 minutes. The separatory funnel was rinsed with a small amount of distilled water and acetic acid was added to the alumina in an amount of about 3% of the weight of the alumina. While still mixing the platinum-impregnated alumina with the planetary mixer, the diluted acetic acid solution was dripped slowly from the separatory funnel onto the alumina.

5. Rh/Al₂O₃

The weight of Rh/Al₂O₃ in the top coat is about 1.25 g/in³. Alumina having a surface area of about 90 m²/g was impregnated with a solution of rhodium nitrate to give in the finished sample a rhodium loading of about 30 g/ft³ Rh. Using a planetary mixer, the alumina was impregnated by slowly dripping the rhodium-nitrate solution from a separatory funnel onto the alumina in the mixing bowl. The separatory funnel was rinsed with a small amount of distilled water.

6. NOₓ Sorbent, Palladium and Slurry Preparation

The platinum-impregnated alumina obtained from step 4 was mixed with distilled water (reserving some for later in the preparation) and octanol. The rhodium-impregnated alumina obtained from step 5 plus barium acetate and zirconium acetate were added to the slurry in amounts to give in the top coat of the finished sample loadings 0.2 g/in³ BaO, 0.08 g/in³ ZrO₂ and 30 g/ft³ Rh. The slurry was continuously milled to attain a particle size of 90% of the particles having a diameter of less than 12 microns. A ceria-zirconia was added to the slurry in an amount to give a loading of 0.25 g/in³ of ceria-zirconia in the finished sample, together with palladium nitrate and the reserved distilled water. The palladium nitrate was omitted in the preparation of Sample A and was added in amounts to give the respective loadings of Pd (50 g/ft³ to 200 g/ft³) noted above for Samples B through E. The slurry was continuously milled to lower the particle size to 90% of the particles having a diameter of less than 9 microns.

7. Coating

The bottom coat-containing substrates obtained from step 3 of Part A of this Example were coated with the slurry obtained from step 6 of this Part B to achieve a target top coat loading of about 2.4 g/in³, including a loading of 0.5 g/in³ of the Pt/Al₂O₃ obtained from step 4 of this Part B. The coated substrates were dried at 110° C. for 4 hours and then calcined at 550° C. for 1 hour in air.

C. Post-dipping

The calcined catalyst was then post-dipped in a solution of cesium nitrate, a NOₓ sorbent precursor compound, in an amount to give in the finished product a weight of 0.3 to 0.4 g/in³ of cesium oxide as the NOₓ sorbent. The post-dipped trap members were then dried at 110° C. for 4 hours and calcined at 550° C. for 1 hour.

D. Testing

The following lean-aging and testing conditions apply not only to the samples of this Example 1, but to all the samples of Examples 2 through 12. All samples to be tested were aged in 10% steam/air for 12 hours at 750° C. prior to testing. In all cases, carrier members on which the washcoats were coated were cordierite members measuring 1.5 inches (3.81 cm) in diameter and 3.0 inches (7.62 cm) in length. The carrier member was tightly packed into a reactor and then heated in air to 250° C. The gas feed described below was then introduced into the reactor with the inlet gas composition maintained lean for 60 seconds and rich for 6 seconds as described below measured across the reactor using FTIR. This cycle was repeated five times and the measured NOₓ conversions (percentage of inlet NOₓ converted to N₂) were averaged over the five cycles.

Test Gas Compositions

The gas composition at lean condition (λ=1.5) contained 10% CO₂, 10% steam, 7.5% O₂, 50 parts per million (“ppm”) by volume HC and 500 ppm NO.

The gas composition at rich conditions (λ=0.86) contained 10% CO₂, 10% steam, 0% O₂, 7.5% CO, 50 ppm Cl hydrocarbon and 500 ppm NO.

The NOₓ conversions attained over the sample catalyzed traps A through E were measured at inlet temperatures of 250, 275, 300, 350, 400, 450, 500, and 550° C.

Test Results

The results of testing are shown graphically in FIG. 5 where the NOₓ conversion curves for samples A through E are plotted to compare the NOₓ conversions attained at various temperatures for different levels of palladium in the samples. The NOₓ conversion curves for each sample are labeled with the corresponding letter, A through E, of the samples of this Example 1. It is clear from FIG. 5 that the addition of palladium to the formulations showed significant enhancement in durability of the aged catalytic traps for NOₓ conversion. Note that for these aged samples, the NOₓ conversion at inlet temperatures of 300° C. for Sample E (200 g/ft³ Pd) was about 85% and that for comparative Sample A (no palladium) was about 20%. FIG. 5 shows that for a temperature range of from about 250 to 375° C. NOₓ conversion efficiency increases with an increase in palladium content.

### EXAMPLE 2

Four specimens of Sample E of Example 1, each containing 200 g/ft³ Pd, were post-dipped with a solution of a different NOₓ sorbent precursor compound, viz, cesium nitrate, potassium acetate, barium acetate and sodium nitrate. The samples were then dried and calcined to give in each case after calcination a loading of the respective NOₓ sorbent, measured as the corresponding oxide, of about 0.35 g/in³. The post-dipped metal salts yielded the respective oxygenated compounds, Cs₂O, K₂O, BaO, and Na₂O. The results of testing of the aged catalyst samples using the procedure described in Part D of Example 1 are given in FIG. 6 wherein the NOₓ conversion curves are labeled Cs, K, Ba and Na to indicate the metal of the post-dipped NOₓ sorbent. It is clear from the test results illustrated in FIG. 6 that the high Pd level of 200 g/ft³ provides excellent NOₓ conversion rates at low temperatures irrespective of the specific NOₓ sorbent used.

### EXAMPLE 3

This example demonstrates the effect of the location of the palladium in the catalyst formulation by comparing (1) the utilization of both palladium and platinum in the bottom coat to (2) the utilization of platinum in the bottom coat and palladium in the top coat.

Samples C-1 and C-2 were prepared exactly as in Example 1 except that in Sample C-1 the palladium (200 g/ft³ Pd) was confined to the top coat (top layer of a two-layer dried and calcined washcoat), whereas in Sample C-2 the 200 g/ft³ of palladium was confined to the bottom coat in admixture with the 60 g/ft³ of platinum. Both samples were post-dipped in a cesium nitrate solution and then dried and calcined to yield 0.35 g/in³ of Cs₂O as the NOₓ sorbent. The NOₓ conversion performances of the two samples were evaluated using the test procedure as described in Part D of Example 1. The results of testing of the two samples is graphically shown in FIG. 7 wherein the NOₓ conversion curves are labeled to show the sample, C-1 or C-2, which the curves represent. Comparison of the two NOₓ conversion curves clearly shows that, at least for high levels of palladium, locating the palladium in the top coat (Sample C-1) is more effective for NOₓ reduction than is locating the palladium in the bottom coat (Sample C-2). Sample C-1 showed excellent NOₓ conversion, after lean aging, in the temperature range of 250 to 550° C. Sample C-2 showed lower NOₓ conversions than Sample C-1 at all temperatures tested. This shows that relegating the palladium to the bottom coat of a layered washcoat is not a preferred formulation, at least for the specific layered composition tested.

### EXAMPLE 4

In this example, a sample denominated Sample C-3 was prepared exactly as in Example 1, except that 200 g/ft³ Pd was divided equally between the bottom and top coats, i.e., 100 g/ft³ of Pd was incorporated in each of the top and bottom coats. Sample C-3 was compared to Sample C-1 of Example 3, in which the 200 g/ft³ Pd is confined to the top coat. Both samples were post-dipped in a cesium nitrate solution and then dried and calcined to yield 0.35 g/in³ of Cs₂O as the NOₓ sorbent. The samples were lean-aged and tested in accordance with Part D of Example 1 and the test data is graphically illustrated in FIG. 8. It is clear from the data of FIG. 8 that dividing the palladium between the two washcoat layers of Sample C-3 provides, at temperatures up to about 400° C., NOₓ conversion similar to the formulation of Sample C-1, where all the palladium was located in the top coat. The NOₓ conversion attained by Sample C-3 at temperatures above 400° C. was, however, lower than that attained by Sample C-1. These results further show the desirability, in a multi-layered washcoat, of concentrating the palladium in the top coat, at least for high-temperature applications.

### EXAMPLE 5

In this Example, a sample denominated Sample C-4 was prepared in accordance with the procedure of Example 1, except that platinum was omitted from the formulation. Sample C-4 contained 200 g/ft³ of Pd and 30 g/ft³ Rh in the top layer and was post-dipped in a cesium nitrate solution and then dried and calcined to yield 0.35 g/in³ of Cs₂O as the NOₓ sorbent. The results of lean aging and testing per Part D of Example 1 of Sample C-4 in comparison to Sample C-1 of Example 3 are graphically illustrated in FIG. 9. FIG. 9 shows NOₓ conversion for Sample C-4 at temperatures up to about 425° C. to be similar to, although not quite as good as, the NOₓ conversion performance of Sample C-1 of Example 3, which contains platinum. The improved NOₓ conversions attained by the platinum-containing Sample C-1, especially at temperatures above about 425° C., shows the desirability of including some platinum in the composition.

### EXAMPLE 6

In this Example, comparative Sample R-2 was made with two layers of washcoat, with no palladium. The bottom coat was made by mixing into a slurry 56% of 2.3% Pt/Al₂O₃, 22.4% of CeO₂—ZrO₂, 15.61% of BaO (from barium acetate), and 3.5% ZrO₂ from zirconyl acetate. The slurry was coated onto the same type carrier member as described in step 7 of Part B of Example 1 to give a washcoat loading of about 2.2 g/in³. The sample was then dried and calcined at 550° C.

The top coat slurry was made of 73% of 0.56% Pt/Al₂O₃, 12.2% of CeO₂—ZrO₂, 9.8% of BaO, 3.9% ZrO₂ and 0.28% Rh. The Pt/Al₂O₃ support was impregnated with a solution of barium acetate, zirconium acetate and rhodium nitrate. This slurry was used to coat the top layer to a washcoat loading of about 2 g/in³. The catalyst was then dried and calcined at 550° C.

The washcoated catalyst was then post dipped into the solution of barium acetate and cesium nitrate to give, respectively, after calcination loadings of about 0.25 g/in³ barium oxide NOₓ sorbent and 0.35 g/in³ cesium oxide NOₓ sorbent, based on the respective oxides. Evaluation of comparative Sample R-2 is discussed below.

### EXAMPLE 7

In this Example, comparative Sample R-3 was prepared in a manner similar to that of Example 6 to provide a catalyzed trap having a total precious metal (platinum plus rhodium) loading of 120 g/ft³. Palladium was omitted from this sample. The top coat contained 80% alumina, 16% BaO from barium acetate, and 3.7% ZrO₂ (from the acetate). The top coat contained 72% of 3% Pt/Al₂O₃, 0.28% Rh from the nitrate, 12% of CeO₂—ZrO₂, and 3% of ZrO₂ from the acetate. After each coating the catalyst was dried and calcined at 550° C. for 1 hour. The total washcoat loading was about 4.2 g/in³. The coated substrate was then post dipped in a solution of barium acetate and cesium nitrate to give, after calcination, loadings of about 0.25 g/in³ barium oxide NOₓ sorbent and 0.35 g/in³ cesium oxide NOₓ sorbent, based on the respective oxides. Evaluation of comparative Sample R-3 is discussed below.

### EXAMPLE 8

In this Example, comparative Sample R-4 was prepared in a manner similar to that of Examples 6 and 7 and, like comparative Sample R-3 of Example 7, comprised a Pt/Rh catalyst without Pd. The top coat contained 71% of 1.6% Pt/alumina, 24% CeO₂—ZrO₂, and 3.8% of ZrO₂ from the acetate. The top coat contained 80% of 1.24% Pt/Al₂O₃, 0.0.62% Rh from the nitrate, 13% of CeO₂—ZrO₂, and 4.3% of ZrO₂ from the acetate. After each coating the catalyst was dried and calcined at 550° C. for 1 hour. The total wash coat loading was about 4.0 g/in³. The coated substrate was then post dipped with a solution of barium acetate and cesium nitrate to give, after calcination, loadings of about 0.25 g/in³ and 0.35 g/in³ of the corresponding barium and cesium oxides. The sample was evaluated as described in Part D of Example 1 and the results are compared with samples in accordance with the present invention in FIGS. 6, 7, and 8.

In Examples 9-11 some or all of the platinum used in the comparative Examples was replaced with palladium.

### EXAMPLE 9

This sample, denominated Sample L, was made in accordance with an embodiment of the present invention with two layers of washcoat, and contained 60 g/ft³ Pt in the bottom coat and 60 g/ft³ Pd in the top coat. The palladium and platinum were therefore segregated one from the other, in separate layers. The top coat contained 71% of 1.6% Pt/alumina, 23% CeO₂—ZrO₂, and 3.7% of ZrO₂ from the acetate. The top coat contained 82% of 1.9% Pd/Al₂O₃, 13.7% of CeO₂—ZrO₂, and 4.4% of ZrO₂ from the acetate. After each coating the catalyst was dried and calcined at 550° C. for 1 hour. The total washcoat loading was about 4.0 g/in³. The coated substrate was then post dipped in a solution of barium acetate and cesium nitrate salts to give the same loadings of barium oxide and cesium oxide NOₓ sorbent as described in Examples 6 and 7 for the comparative samples, followed by drying and calcining at 550° C. for 1 hour.

Sample L was evaluated for NOₓ reduction by the lean aging and testing as described in Part D of Example 1 in comparison to the palladium-free comparative Samples R2, R-3 and R-4 of Examples 6, 7 and 8, respectively. The resulting NOₓ conversion curves are shown in FIG. 10.

FIG. 10 shows significantly higher NOₓ conversion for Sample L than for the comparative samples up to nearly 400° C. and comparable or better results at higher temperatures. This demonstrates not only the efficacy of a high loading of palladium in improving NOₓ conversion, especially at low temperatures, after severe lean aging, but the excellent performance attained by a layered washcoat composition, in which the platinum and palladium are segregated from each other, in discrete washcoat layers.

### EXAMPLE 10

Sample M in accordance with an embodiment of the present invention was prepared with two layers of washcoat including 90 g/ft³ Pd in the top coat and 30 g/ft³ Pt in the bottom coat. Sample M thus, like Sample L of Example 9, segregates the platinum and palladium by placing them in separate, discrete layers of washcoat. The bottom coat contained 71.5% of 0.8% Pt/alumina, 24% CeO₂—ZrO₂, and 3.7% of ZrO₂ from a solution of zirconium acetate. The top coat contained 82% of 2.85% Pd/Al₂O₃, 13.7% of CeO₂—ZrO₂, and 4.4% of ZrO₂ from a solution of zirconium acetate. After each coating the sample was dried and calcined at 550° C. for 1 h. The total washcoat loading was about 4.0 g/in³. The coated substrate was then post dipped in a solution of barium acetate and cesium nitrate to provide the barium and cesium NOₓ sorbent loadings as described above in Examples 6 and 7 for the comparative samples, followed by drying and calcining at 550° C. for 1 hour. This sample was lean-aged and evaluated as described in Part D of Example 1 in comparison to the palladium-free comparative Samples R-2, R-3 and R-4 of Examples 6, 7 and 8, respectively, and the resulting NOₓ conversion curves are shown in FIG. 11.

FIG. 11 shows significantly higher NOₓ conversions for Sample M than for the comparative samples at temperatures up to about 425° C., and comparable or better results at higher temperatures. These data show that replacing 90 g/ft³ Pt with 90 g/ft³ palladium provided better NOₓ conversion after severe lean aging and that excellent performance is attained by Sample M, in which the platinum and palladium are segregated in separate, discrete layers of washcoat.

### EXAMPLE 11

Sample H in accordance with an embodiment of the present invention was prepared with two layers of washcoat including 150 g/ft³ Pd in the top coat and no platinum in the bottom coat. The bottom coat contained 80% alumina, and 16% of BaO from barium acetate, 3.7% of ZrO₂ from the acetate. The top coat contained 71% of 4% Pd/Al₂O₃, 12% of CeO₂—ZrO₂, and 3.8% of ZrO₂ from the acetate. After each coating the catalyst was dried and calcined at 550° C. for 1 hour. The total wash coat loading was about 4.3 g/in³. The coated substrate was then post dipped in a solution of barium acetate and cesium nitrate to attain the same barium and cesium NOₓ sorbent loadings as described in Examples 6 and 7 for the comparative samples, followed by drying and calcining at 550° C. for 1 hour.

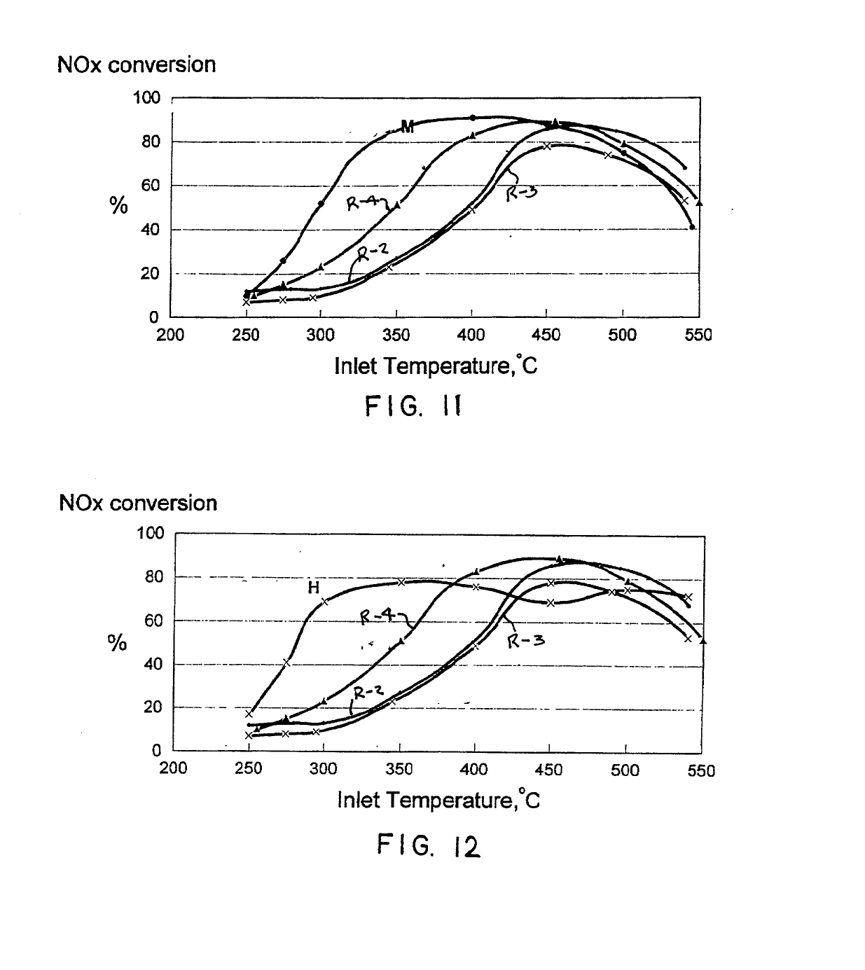

Sample H was evaluated for NOₓ reduction as described in Part D of Example 1 in comparison to comparative Samples R-2, R-3 and R-4 of Examples 6, 7 and 8, respectively,, and the resulting NOₓ conversion curves are shown in FIG. 12. FIG. 12 shows significantly higher NOₓ conversions for Sample H as compared to the comparative samples at temperatures up to about 380° C. and comparable or better results at higher temperatures. This shows the efficacy of a composition in accordance with an embodiment of the present invention which contains a high loading of palladium and no platinum or rhodium.

It is clear from the comparison of Samples H, L and M in accordance with embodiments of the present invention with the comparative samples of Examples 6-8, that the addition of palladium in quantities above 50 g/ft³, partly or entirely replacing platinum in the overall composition,, resulted in great enhancement of low temperature NOₓ conversion after lean aging at 750° C. for 12 hours. Addition of at least 50 g/ft³ Pd to the top or bottom washcoat layer showed a significant improvement in NOₓ conversion. Moreover, using palladium alone in a concentration above about 50 g/in³, without platinum or rhodium in the formulation, also showed high NOₓ conversion in both the low and high temperature ranges of operation.

### EXAMPLE 12

Two catalytic trap samples were prepared in accordance with the procedure of Example 1 with post-dipping of the carrier member having a calcined two-layer washcoat into a solution of precursor compounds of the NOₓ sorbents barium oxide and cesium oxide. The two samples were prepared identically, except for the post-dipping step.

Both samples were prepared with two layers of washcoat. The bottom coat contained 60 g/ft³ Pt and 15 g/ft³ Rh and the top coat contained 90 g/ft³ Pd. The bottom coat contained 56.5% of 1.6% Pt/alumina, 23% CeO₂—ZrO₂, 3.7% ZrO₂ obtained from a solution of zirconium acetate, and 15.8% BaO obtained from a solution of barium acetate. The top coat contained 72% of 2.5% Pd/Al₂O₃, 12% CeO₂—ZrO₂ and 4% ZrO₂, the latter obtained from a solution of zirconium acetate, and 9.6% BaO obtained from a solution of barium acetate. After each coating the coated sample was dried and calcined at 550° C. for 1 hour. The total washcoat loading was about 4.0 g/in³.

Sample R-5

The entire washcoated substrate was then post-dipped in a solution of Ba and Cs soluble precursor compound salts so that the loading of the corresponding oxides based on the calcined weight of the precursor compound catalyst was 0.25 g/in³ of BaO and 0.35 g/in³ of Cs₂O. The substrate was then dried and calcined at 550° C. for 1 hour.

Sample I

The front-end half of the wash-coated substrate was post-dipped in a barium acetate solution so that the loading in the finished sample based on the oxide BaO was 0.25 g/in³. The back-end half was post-dipped with a solution containing barium acetate and cesium nitrate solution so that the final loading of the corresponding oxides based on the calcined weight of the finished sample was 0.25 g/in³ BaO and 0.35 g/in³ Cs₂O. The substrate was then dried and calcined at 550° C. for 1 hour.

Testing

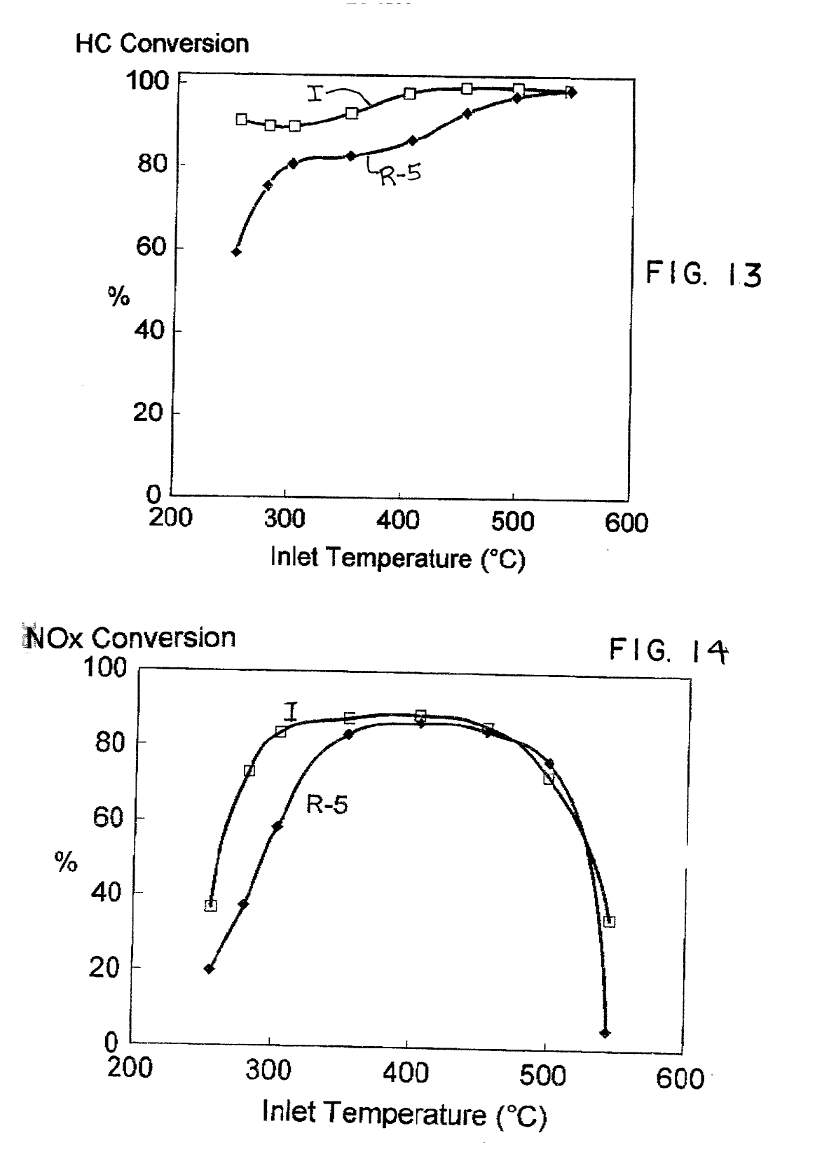

Samples R-5 and I were then evaluated for NOₓ and hydrocarbon conversion as described in Part D of Example 1 and the resulting HC conversion curves are shown in FIG. 13.

It is clear from examining the hydrocarbon conversion curves of FIG. 13 that zone-dipping the front half of the substrate to provide therein a barium oxide NOₓ sorbent and the rear half to provide a barium oxide and cesium oxide NOₓ sorbent resulted in significant improvement in hydrocarbon conversion. The “front half” is the portion of the catalytic trap into which the gas stream to be treated or tested is introduced. The NOₓ conversions attained by Samples I and R-2 were comparable to those of other embodiments of the invention. The NOₓ conversion attained by Sample I was not adversely affected by the zoned use of the NOₓ sorbents BaO and Cs₂O as is shown by the NOₓ conversion curves for Samples I and R-5 in FIG. 14. In fact, at temperatures up to about 350° C., Sample I shows better NOₓ conversion than does Sample R-5.

A further improvement in the durability of catalytic trap materials that contain a basic oxygenated compound of potassium as the NOₓ sorbent follows from the observation that potassium-based NOₓ sorbents tend to react with certain carrier member materials such as cordierite, thereby diminishing the amount of effective NOₓ sorbent in the catalytic material. The improvement in durability is the result of coating the catalytic trap material onto a carrier substrate, such as a metal, alumina or titania substrate, which does not react with, or at least does not react to a significant degree with, the basic oxygenated potassium compounds under conditions of use of the catalytic trap. Without wishing to be bound by any particular theory, it is believed that the loss in effectiveness of catalytic trap materials that contain potassium basic oxygenated compounds and that are coated onto carrier members, such as those made of cordierite, which are reactive therewith, is the result of interaction between the potassium compounds and the, e.g., cordierite, that occurs when the coated carrier member is subjected to conditions of use in treating the exhaust of lean-burn or partial lean-burn engines and/or to lean aging conditions. By using a refractory metal carrier member, for example, the interaction between the potassium and the cordierite is avoided, thus providing the observed improvement in durability. Similar improvement can be obtained by using carrier members made of materials other than refractory metals, provided they are not reactive with the basic oxygenated potassium compounds. The potassium compound interaction is believed to involve the formation of potassium silicates, so that carriers made from ceramic-like materials that do not contain silicates, or that are otherwise non-reactive with such potassium compounds, are also usable. The appropriate carrier substrates for use with basic oxygenated potassium compound-containing catalytic trap materials in accordance with the present invention are sometimes referred to herein as “potassium-inert” materials.

Testing has shown that catalytic trap materials containing a potassium basic oxygenated compound demonstrated much greater durability at temperatures above about 400° C. when coated on a stainless steel carrier member than did an identical catalytic trap material coated onto a cordierite material, after treatment over eight cycles of lean followed by rich operation at temperatures of the inlet test gas of from about 200 to 500° C. In contrast, otherwise identical catalytic trap materials in which a cesium basic oxygenated compound was substituted for the potassium basic oxygenated compound showed no significant difference between being coated onto a cordierite and a stainless steel carrier member. In fact, the cesium compound-containing catalytic trap materials coated on both cordierite and stainless steel carrier members, and the potassium compound-containing catalytic trap material coated on a cordierite carrier member, all showed NOₓ conversion performance which was inferior at temperatures of about 400 to 500° C. to that of the potassium compound-containing catalytic trap material coated on a stainless steel carrier member.

The improved performance of potassium compound-containing catalytic trap material coated onto a potassium-inert carrier member is not necessarily limited to the high (at least 25 g/ft³) loadings of palladium in accordance with the present invention, but is broadly applicable to a catalytic trap material comprising a refractory metal oxide support having dispersed therein (i) a catalytic component (e.g., one or more of platinum, palladium and rhodium) effective for promoting the reduction of NOₓ, and (ii) a NOₓ sorbent comprising one or more basic oxygenated compounds of potassium and, optionally, one or more other alkali metals, alkaline earth metals and rare earth metals.

While the invention has been described in detail with respect to specific embodiments thereof, such embodiments are illustrative and the scope of the invention is defined in the appended claims.

What is claimed is:

1. A catalytic trap for conversion of NOₓ in an exhaust gas stream comprises:
(a) a catalytic trap material comprising
(i) a refractory metal oxide support having dispersed thereon a palladium catalytic component in the amount of at least about 25 g/ft³ Pd.
(ii) a NOₓ sorbent comprising one or more basic oxygenated compounds of one or more metals selected from the group consisting of alkali metals and alkaline earth metals,
(iii) optionally, a catalytically effective amount of a platinum catalytic component, and
(iv) optionally, a catalytically effective amount of a rhodium catalytic component; and
(b) a refractory carrier member on which the catalytic trap material is coated.

2. The catalytic trap of claim 1 wherein the palladium catalytic component is present in the amount of from about 25 g/ft³ Pd to about 300 g/ft³ Pd.

3. The catalytic trap of claim 1 wherein the palladium catalytic component is present in the amount of from about 30 g/ft³ Pd to about 250 g/ft³ Pd.

4. The catalytic trap of claim 1 wherein the NOₓ sorbent is selected from the group consisting of one or more basic oxygenated compounds of lithium, sodium, potassium, cesium, magnesium, calcium, strontium and barium.

5. The catalytic trap of claim 4 wherein the NOₓ sorbent is present in the amount of from about 0.1 to 2.5 g/in³.

6. The catalytic trap of claim 3, claim 4 or claim 5 wherein the NOₓ sorbent comprises basic oxygenated compounds of one or both of cesium and potassium present in the total amount of about 0.1 to 1.5 g/in³.

7. The catalytic trap of claim 6 wherein the NOₓ sorbent comprises a basic oxygenated compound of cesium present in the amount of about 0.1 to 1.5 g/in³.

8. The catalytic trap of claim 7 wherein the NOₓ sorbent further comprises a basic oxygenated compound of barium.

9. The catalytic trap of claim 1 wherein the platinum catalytic component, when present, is present in the amount of from about 0.1 g/ft³ to 90 g/ft³ Pt and the rhodium catalytic component, when present, is present in an amount of from about 0.1 g/ft³ to 50 g/ft³ Rh.

10. The catalytic trap of claim 9 wherein the platinum catalytic component and the rhodium catalytic component are both present and wherein the palladium catalytic component is present in the amount of from about 25 g/ft³ to about 300 g/ft³ Pd, and the NOₓ sorbent is present in the amount of from about 0.1 to 2.5 g/in³.

11. The catalytic trap of claim 10 wherein the NOₓ sorbent comprises a basic oxygenated compound of cesium.

12. The catalytic trap of claim 10 or claim 11 wherein the NOₓ sorbent further comprises a basic oxygenated compound of barium.

13. The catalytic trap of claim 1 wherein the catalytic trap material is carried on the carrier member in at least two discrete layers, and the palladium catalytic component is disposed in the top layer.

14. The catalytic trap of claim 1 wherein the catalytic trap material comprises the platinum catalytic component and is carried on the carrier member in at least two discrete layers, with substantially all the platinum catalytic component present being disposed in one layer and substantially all the palladium catalytic component present being disposed in the other layer.

15. The catalytic trap of claim 14 wherein the palladium catalytic component is present in the one layer in the amount of from about 25 g/ft³ to about 300 g/ft³ Pd and the platinum catalytic component is present in the other layer in the amount of from about 0.1 to 90 g/ft³ Pt.

16. The catalytic trap of claim 14 or claim 15 wherein the two layers comprise a bottom layer and a top layer and the palladium catalytic component is disposed in the top layer and the platinum catalytic component is disposed in the bottom layer.

17. The catalytic trap of claim 14 and claim 15 wherein a rhodium catalytic component is dispersed in the layer containing the platinum catalytic component.

18. The catalytic trap of claim 9 wherein the refractory metal oxide support is selected from the group consisting of alumina, silica, titania, zirconia, baria-zirconia, ceria-zirconia, lanthana-zirconia, titania-zirconia, silica-zirconia, baria-zirconia-alumina, and lanthana-zirconia-alumina.

19. The catalytic trap of claim 9 wherein the NOₓ sorbent is selected from the group consisting of one or more basic oxygenated compounds of sodium, potassium, cesium, strontium and barium.

20. The catalytic trap of claim 9 wherein the NOₓ sorbent is dispersed on the refractory metal oxide support by impregnating the support with a dispersion of one or more precursors of the basic oxygenated compounds in a liquid vehicle and thereafter dried and heated to decompose the one or more precursors to the one or more basic oxygenated compounds.

21. The catalytic trap of claim 1 or claim 9 wherein the carrier member has a longitudinal axis and a plurality of parallel gas-flow passages extending longitudinally therethrough from a front face to a rear face of the carrier member, the gas-flow passages being defined by walls on which the catalytic NOₓ sorbent is coated, and the NOₓ sorbent comprises basic oxygenated compounds of one or both of cesium and potassium disposed only in a rear segment of the carrier member defined between the rear face of the carrier member and an intermediate point along the longitudinal axis thereof, whereby basic oxygenated compounds of cesium and potassium are excluded from a front segment of the carrier member defined between the front face of the carrier member and the said intermediate point.

22. The catalytic trap of claim 21 wherein the distance from the front face of the carrier to the intermediate point comprises from about 20 percent to 80 percent of the length of the carrier along its longitudinal axis.

23. The catalytic trap of claim 21 wherein the carrier member comprises a plurality of discrete carrier member sections arranged in series flow communication along the longitudinal axis and the rear segment and the front segment are comprised of respective discrete carrier member sections.

24. The catalytic trap of any one of claims 1, 2, 3, 9 or 10 in combination with a treatment catalyst disposed upstream of the catalytic trap relative to the exhaust gas stream, the treatment catalyst being effective at least to promote under oxidation conditions the oxidation of hydrocarbons to CO₂ and H₂O.

25. A method of manufacturing a catalytic trap for conversion of NOₓ in an exhaust gas stream comprises:
(a) preparing a catalytic trap material by
(i) dispersing onto a refractory metal oxide support a palladium catalytic component in the amount of at least about 25 g/ft³ Pd by impregnating the support with a solution of a precursor palladium compound in a liquid vehicle to provide a supported palladium catalytic component;
(ii) combining with the supported palladium catalytic component a NOₓ sorbent comprising one or more basic oxygenated compounds of one or more metals selected from the group consisting of alkali metals and alkaline earth metals;
(b) coating the catalytic trap material onto a refractory carrier member; and
(c) drying and then heating the resulting coated refractory carrier member.

26. The method of claim 25 wherein the catalytic trap material is coated onto the refractory carrier member in at least two layers and substantially all of the palladium catalytic component present is dispersed in one layer and substantially all the platinum catalytic component present is dispersed in the other layer.

27. The method of claim 25 including combining the NOₓ sorbent with the support by impregnating the support with a dispersion of one or more precursors of one or more of the basic oxygenated metal compounds in a liquid vehicle, and drying and heating the impregnated support to decompose the one or more precursors to the NOₓ sorbent.

28. The method of claim 25 wherein the carrier member comprises a honeycomb-type carrier member having a plurality of parallel gas-flow passages extending longitudinally therethrough from a front face to a rear face of the carrier member, the gas-flow passages being defined by walls on which the catalytic trap material is coated, and wherein step (a)(i) of claim 21 is carried out prior to step (a)(ii) of claim 21.

29. The method of claim 28 wherein the palladium catalytic component is dispersed onto the refractory metal oxide support in the amount of from about 25 g/ft³ to about 300 g/ft³ Pd and the method further comprises incorporating into the catalytic trap material one or both of (1) a catalytically effective amount of a platinum catalytic component and (2) a catalytically effective amount of a rhodium catalytic component; and
wherein the NOₓ sorbent is selected from the group consisting of one or more basic oxygenated compounds of lithium, sodium, potassium, cesium, magnesium, calcium, strontium and barium.

30. The method of claim 29 further comprising disposing basic oxygenated compounds of one or both of cesium and potassium only between the rear face of the carrier member and an intermediate point along the longitudinal axis thereof, whereby basic oxygenated compounds of cesium and potassium are excluded from between the front face of the carrier member and the said intermediate point.

31. The method of claim 27, claim 28 or claim 29 including the steps of (i) coating the supported palladium catalytic component onto the refractory carrier member; (ii) drying and heating the resulting coating to provide a palladium catalytic washcoat; (iii) after step (ii), dipping the carrier member into a solution of one or more NOₓ precursor compounds to impregnate the one or more NOₓ precursor compounds into the palladium catalytic washcoat; and (iv) drying and heating the dipped carrier member obtained from step (iii) to decompose the one or more NOₓ precursor compounds into the NOₓ sorbent.

32. The method of claim 27, claim 28 or claim 29 wherein the metals of the basic oxygenated alkali metal compounds are selected from the group consisting of one or more of sodium, potassium and cesium, and the metals of the basic oxygenated alkaline earth metal compounds are selected from the group consisting of one or more of calcium, strontium and barium.

33. The method of claim 32 wherein the metal of the basic oxygenated compounds comprises cesium.

34. The method of claim 32 wherein the metals of the basic oxygenated compounds comprise cesium and barium.

35. A method of treating an exhaust gas stream comprises contacting the stream with the catalytic trap of any one of claims 1, 2, 4 or 10 under alternating periods of (1) lean and (2) stoichiometric or rich operation at conditions whereby at least some of the NOₓ in the exhaust gas stream is trapped in the catalytic material during the periods of lean operation and is released and reduced to nitrogen during the periods of stoichiometric or rich operation.

36. The method of claim 35 wherein the exhaust gas stream contains hydrocarbons and further comprising contacting the exhaust gas stream under oxidizing conditions with a catalyst effective to promote oxidation of hydrocarbons, whereby to oxidize hydrocarbons contained therein, prior to contacting the exhaust gas stream with the catalytic trap.
